(19) United States
(12) Patent Application Publication
(10) Pub. No.: US 2012/0127973 A1
(43) Pub. Date: May 24, 2012

(54) SYSTEM AND METHOD OF SENDING ACKNOWLEDGMENTS THROUGH CONTROL CHANNELS TO PREVENT UNNECESSARY RETRANSMISSION IN A LIMITED BANDWIDTH WIRELESS COMMUNICATION NETWORK

(76) Inventors: James LIN, San Diego, CA (US); Arvind SANTHANAM, San Diego, CA (US)

(21) Appl. No.: 12/949,774

(22) Filed: Nov. 18, 2010

(51) Int. Cl. H04W 92/00; H04B 7/00

(52) U.S. Cl. 370/338; 455/507

(57) ABSTRACT

Techniques for increasing throughput during a file sharing operation including a mobile device are provided. Throughput can be increased by reducing the number of times packets are retransmitted due to ACK signals being delayed due to the lossy nature of over-the-air transmissions.

### BACKGROUND

The present invention generally relates to wireless telecommunication systems. More particularly, the present invention relates to techniques for increasing throughput over a wireless network during a file sharing operation.

The situation where many files are shared at the same time may arise in a low bandwidth cellular environment and the unregulated transmission of files on forward and reverse links by mobile devices can impact throughput and may result in increased delay of file transfers or impede the user experience. For example, in sliding window protocols if ACKs are not received quickly, the data throughput of the channel will reduce significantly as it can cause both communication sides to trigger retransmission and/or backoff. This problem is more likely to occur in a low bandwidth or a bottlenecked connection because in a higher bandwidth connection, the ACK would have been sent before the timeout expired.

Accordingly, techniques for increasing throughput during a file sharing operation are desirable.

### SUMMARY

An embodiment of the present disclosure includes a system, in the example embodiment, the system includes, but is not limited to, a first base transceiver station; a mobile device configured to send first data to the base transceiver station over a reverse link of a first wireless channel; wherein the mobile device is configured to receive second data sent from the base transceiver station on a forward link of the first wireless channel while sending the first data to the base transceiver station over the reverse link of the first wireless channel; wherein the mobile device is configured to send an acknowledgement signal for the second data to the base transceiver station on a second wireless channel while sending the first data to the base transceiver station over the reverse link of the first channel. In addition to the foregoing, other system techniques are described in the detailed description, the drawings, and the appended claims.

An embodiment of the present disclosure includes a system, in the example embodiment, the system includes, but is not limited to, a mobile device configured to store a first portion of first data and a second portion of the first data in a wireless transceiver queue; wherein the mobile device is configured to send the first portion of the first data to a base transceiver station over a reverse link of a wireless channel; wherein the mobile device is configured to receive second data sent from the base transceiver station on a forward link of the wireless channel while sending the first portion of the first data to the base transceiver station over the reverse link of the wireless channel; wherein the mobile device is configured to store an acknowledgement signal for the second data into a second queue; and wherein the mobile device is configured to send the stored acknowledgment signal for the second data over the reverse link of the wireless channel before sending the second portion of the first data. In addition to the foregoing, other system techniques are described in the detailed description, the drawings, and the appended claims.

An embodiment of the present disclosure includes a method, in the example embodiment, the method includes, but is not limited to, sending first data over a reverse link of a wireless channel, the first data associated with a first protocol stream; generating, while sending the first data over the reverse link of the wireless channel, an acknowledgment for received second data; associating the acknowledgment with a second stream; and sending the acknowledgment over the reverse link of the first channel before at least a portion of the first data has been sent over the first channel. In addition to the foregoing, other method techniques are described in the detailed description, the drawings, and the appended claims.

An embodiment of the present disclosure includes a method, in the example embodiment, the method includes, but is not limited to, simultaneously sending first data and receiving second data via a wireless channel; determining that the second data has be received and that the first data is being sent; and sending an acknowledgment for the second data via a priority wireless channel, wherein the wireless channel is a different channel than the priority wireless channel. In addition to the foregoing, other method techniques are described in the detailed description, the drawings, and the appended claims.

An embodiment of the present disclosure includes a method, in the example embodiment, the method includes, but is not limited to, simultaneously uploading first data and downloading second data via a wireless channel; completing the download of the second data; determining that an acknowledgment for the downloaded second data would not be sent within a time limit based on the bandwidth of the wireless channel and an amount of first data stored in a queue; and sending the acknowledgment for the second data via a second wireless channel. In addition to the foregoing, other method techniques are described in the detailed description, the drawings, and the appended claims.

An embodiment of the present disclosure includes a method, in the example embodiment, the method includes, but is not limited to, simultaneously uploading first data and downloading second data via a second wireless channel; receiving information that indicates that the load on a base transceiver station is below a predetermined threshold; and sending an acknowledgment for the second data via a second wireless channel. In addition to the foregoing, other method techniques are described in the detailed description, the drawings, and the appended claims.

An embodiment of the present disclosure includes a method, in the example embodiment, the method includes, but is not limited to, simultaneously uploading first data and downloading second data via a wireless channel; determining that an acknowledgment for the downloaded second data would not be sent within a time limit based on the bandwidth of the wireless channel and an amount of first data stored in a queue; associating the acknowledgment for the second data with a prioritized stream; and sending the acknowledgment for the second data ahead of at least a part of the first data stored in the queue. In addition to the foregoing, other method techniques are described in the detailed description, the drawings, and the appended claims.

An embodiment of the present disclosure includes a method, in the example embodiment, the method includes, but is not limited to, simultaneously uploading first data associated with a first stream and downloading second data via a wireless channel; determining that the load on a base transceiver station is below a predetermined threshold based on information that indicates the current load on the base station; associating an acknowledgment for the second data with a second stream; and sending the acknowledgment for the second data ahead of at least a part of the first data stored in the queue. In addition to the foregoing, other method techniques are described in the detailed description, the drawings, and the appended claims.

An embodiment of the present disclosure includes a method, in the example embodiment, the method includes, but is not limited to, queuing first data in a protocol stack, the first data associated with a first port number; generating, while a first portion of the first data is being sent over a reverse link of a wireless channel, an acknowledgment for received second data; queuing, while the first portion of first data is being sent over the reverse link of the wireless channel, the acknowledgment for the received second data, the acknowledgment associated with a second port number; and transmitting the acknowledgment over the reverse link of the wireless channel ahead of at least a second portion of the first data. In addition to the foregoing, other method techniques are described in the detailed description, the drawings, and the appended claims.

An embodiment of the present disclosure includes a method, in the example embodiment, the method includes, but is not limited to, queuing first data in a protocol stack, the first data associated with a first port number; generating, while the first data is being sent over a reverse link of a first wireless channel, an acknowledgment for received second data; queuing, while the first data is being sent over the reverse link of the first wireless channel, the acknowledgment for the received second data, the acknowledgment associated with a second port number; and transmitting, while the first data is being sent over the reverse link of the first wireless channel, the acknowledgment over a reverse link of a second wireless channel. In addition to the foregoing, other method techniques are described in the detailed description, the drawings, and the appended claims.

An embodiment of the present disclosure includes a method, in the example embodiment, the method includes, but is not limited to, simultaneously sending first data associated with a first logical channel mapped to a physical wireless channel and receiving second data over the physical wireless channel; and sending an acknowledgment for received second data in a second logical channel mapped to the physical wireless channel. In addition to the foregoing, other method techniques are described in the detailed description, the drawings, and the appended claims.

An embodiment of the present disclosure includes a method, in the example embodiment, the method includes, but is not limited to, simultaneously sending first data and receiving second data over a physical wireless channel; and sending an acknowledgment for received second data over a second physical wireless channel. In addition to the foregoing, other method techniques are described in the detailed description, the drawings, and the appended claims.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 describes an exemplary computer system.

FIG. 2 depicts an exemplary mobile communication device.

FIG. 3 depicts an exemplary mobile device.

FIG. 4A depicts an exemplary mobile device having a single wireless transceiver.

FIG. 4B depicts an exemplary mobile device having multiple wireless transceivers.

FIG. 5 shows an exemplary wireless network.

FIG. 6 depicts an operational procedure for practicing aspects of the present disclosure.

FIG. 7 depicts an alternative embodiment of the operational procedure of FIG. 6.

FIG. 8 depicts an operational procedure for practicing aspects of the present disclosure.

FIG. 9 depicts an alternative embodiment of the operational procedure of FIG. 9.

### DETAILED DESCRIPTION

In this disclosure, the terms ‘communication device,’ ‘wireless telephone,’ ‘wireless communications device,’ ‘PTT communication device,’ ‘handheld device,’ ‘wireless communication device,’ ‘handset,’ ‘access terminal,’ ‘mobile device,’ and ‘mobile station’ are used interchangeably. The terms ‘call’ and ‘communication’ are also used interchangeably. The term ‘exemplary’ means that the disclosed element or embodiment is only an example, and does not indicate any preference of use. Further, like numerals refer to like elements throughout the several drawings, and the articles “a” and “the” include plural references, unless otherwise specified in the description. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The term circuitry used throughout the disclosure can include hardware components such as application specific integrated circuits, hardware interrupt controllers, hard drives, network adaptors, graphics processors, hardware based video/audio codecs, and the firmware/software used to operate such hardware. The term circuitry can also include microprocessors configured to perform function(s) by firmware or by switches set in a certain way or one or more logical processors, e.g., one or more cores of a multi-core general processing unit. Logical processor(s) can be configured by software instructions embodying logic operable to perform function(s) that are loaded from memory, e.g., RAM, ROM, firmware, etc. In example embodiments where circuitry includes a combination of hardware and software an implementer may write source code embodying logic that is subsequently compiled into machine readable code that can be executed by a logical processor. Since one skilled in the art can appreciate that the state of the art has evolved to a point where there is little difference between hardware, software, or a combination of hardware/software, the selection of hardware versus software to effectuate functions is merely a design choice. Thus, since one of skill in the art can appreciate that a software process can be transformed into an equivalent hardware structure, and a hardware structure can itself be transformed into an equivalent software process, the selection of a hardware implementation versus a software implementation is left to an implementer. As used herein a “physical” channel is intended to encompass an established data channel that is allocated a specific amount of bandwidth for the handling of voice and/or data. The term “logical” channel is intended to encompass a virtual or artificially created channel that can be dedicated to the handling of specific data, but is not specifically allocated a set amount of bandwidth of a physical channel for communication, or is necessarily limited to utilization of a specific physical channel. The term “QoS” means quality of service, or the ability to provide different priority to different applications, users, or data flows, or to guarantee a certain level of performance to a data flow. QoS does not necessarily mean the overall achieved service quality of any one particular channel.

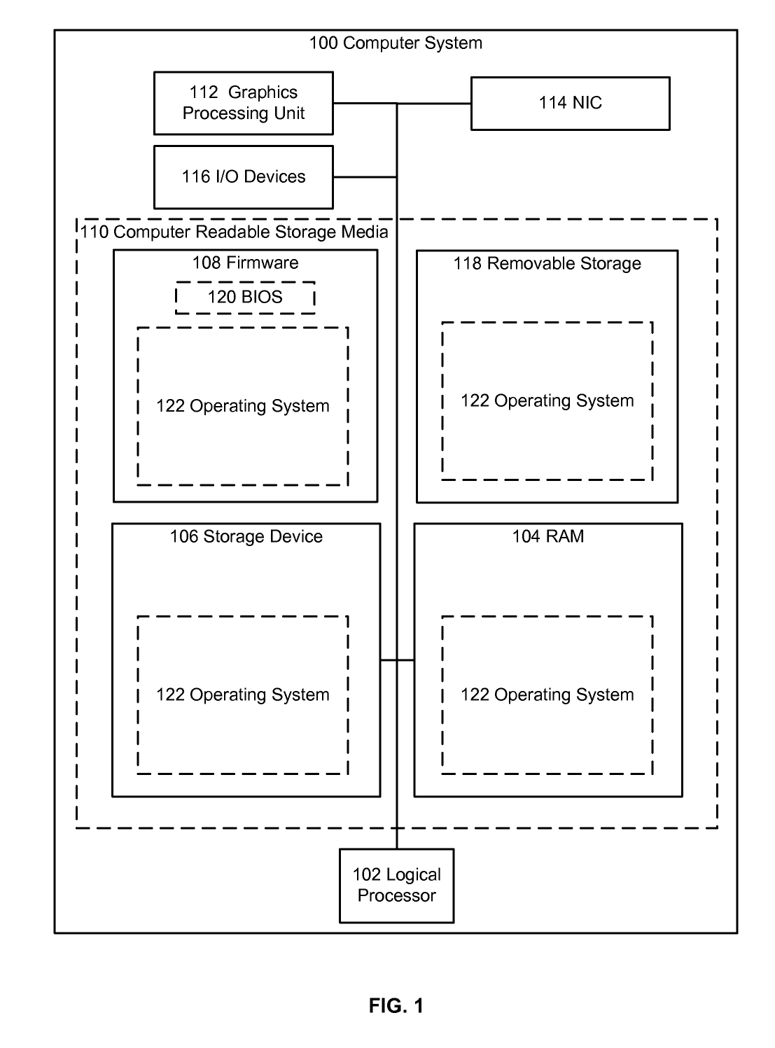

Embodiments may execute on one or more computers. FIG. 1 and the following discussion are intended to provide a brief general description of a suitable computing environment in which the disclosure may be implemented. One skilled in the art can appreciate that computer systems disclosed herein can have some or all of the components described with respect to computer 100 of FIG. 1.

Referring now to FIG. 1, an exemplary computer system 100 is depicted. Computer system 100 can include a logical processor 102, e.g., an execution core. While one logical processor 102 is illustrated, in other embodiments computer system 100 may have multiple logical processors, e.g., multiple execution cores per processor substrate and/or multiple processor substrates that could each have multiple execution cores. As shown by the figure, various computer readable storage media 110 can be interconnected by a system bus which couples various system components to the logical processor 102. The system bus may be any of several types of bus structures including a memory bus or memory controller, a peripheral bus, and a local bus using any of a variety of bus architectures. In example embodiments the computer readable storage media 110 can include for example, random access memory (RAM) 104, storage device 106, e.g., a electromechanical hard drive, a solid state hard drive, etc., firmware 108, e.g., FLASH RAM or ROM, and removable storage 118 such as, for example, CD-ROMs, floppy disks, DVDs, FLASH drives, external storage devices, etc. It should be appreciated by those skilled in the art that other types of computer readable storage media can be used to store data, such as magnetic cassettes, flash memory cards, digital video disks, Bernoulli cartridges, etc.

The computer readable storage media 110 provides storage of computer readable instructions, data structures, program modules and other data for the computer 100. A basic input/output system (BIOS) 120, containing the basic routines that help to transfer information between elements within the computer system 100, such as during start up, can be stored in firmware 108. A number of applications 124 and an operating system 122 may be stored on firmware 108, storage device 106, RAM 104, and/or removable storage devices 118, and executed by logical processor 102.

Commands and information may be received by computer 100 through input devices 116 which can include, but are not limited to, keyboards and pointing devices. Other input devices may include microphones, joysticks, game pads, scanners or the like. These and other input devices are often connected to the logical processor 102 through a serial port interface that is coupled to the system bus, but may be connected by other interfaces, such as a parallel port, game port or universal serial bus (USB). A display or other type of display device can also be connected to the system bus via an interface, such as a video adapter which can be part of, or connected to, a graphics processor 112. In addition to the display, computers typically include other peripheral output devices (not shown), such as speakers and printers. The exemplary system of FIG. 1 can also include a host adapter, Small Computer System Interface (SCSI) bus, and an external storage device connected to the SCSI bus.

Computer system 100 may operate in a networked environment using logical connections to one or more remote computers, such as a remote computer. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through a network interface card 114 (NIC). The NIC 114, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

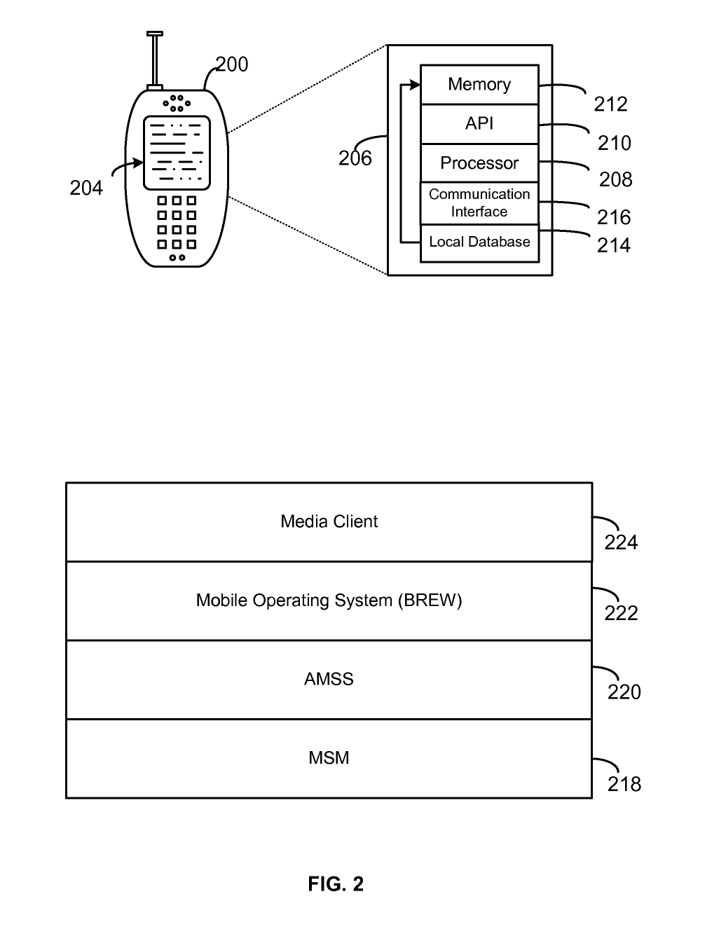

Referring now to FIG. 2, illustrated is a mobile device 200 including a display 204. The mobile device 200 can include a computer platform 206 that can handle voice and data packets, execute software applications, and transmit information across a wireless network. The computer platform 206 includes, among other components, at least one processor 208 such as an application-specific integrated circuit (“ASIC”) or a RISC processor such as those that implement the ARM architecture. The processor 208 is installed at the time of manufacture of the wireless communication device 200 and is not normally upgradeable. The processor 208 can execute an application programming interface (“API”) layer 210, which can include an operating system which can control the hardware of the mobile device. An example of an operating system is the “binary runtime environment for wireless” (BREW) software developed by QUALCOMM® for wireless communication device platforms.

As shown here, the mobile device 200 can be a wireless communication telephone, but can also be any wireless device with a computer platform 206 as known in the art, such as a personal digital assistant (PDA), a pager with a graphics display, or even a separate computer platform 206 that has a wireless communication portal, and may otherwise have a wired connection to a network or the Internet. Memory, i.e., computer readable storage media, 212 can be comprised of read-only or random-access memory (RAM and ROM), EPROM, EEPROM, flash cards, or any memory common to computer platforms. The computer platform 206 can also include a local database 214 for storage of software applications not actively in memory 212. The local database 214 is typically comprised of one or more flash memory cells, but can be any secondary or tertiary storage device as known in the art, such as magnetic media, EPROM, EEPROM, optical media, tape, or soft or hard disk.

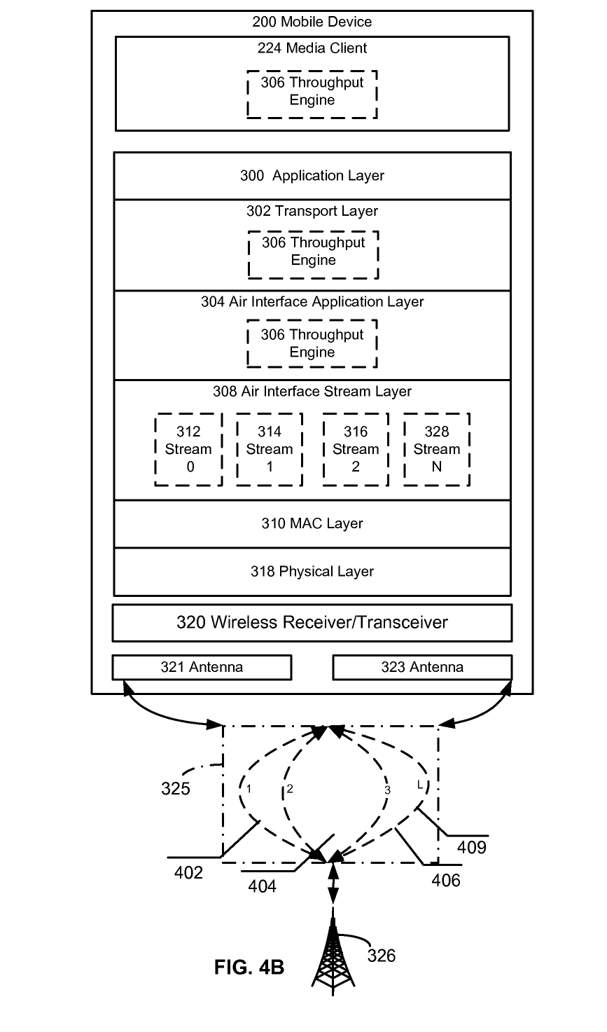

The computer platform 206 can also include a communication interface 216 that can be used to open a data channel to with an endpoint such as a media server 530 of FIG. 5. The communication interface 216 can also be part of the standard communication interface for the mobile device 200 which ordinarily carries the voice and data transmitted to and from the wireless communication device 200. The communication interface 216 typically is comprised of hardware that is known in the art.

Continuing with the description of FIG. 2, additionally depicted is a diagram of an embodiment of the software layers of that can execute in the mobile device 200. In an embodiment, the computer platform 206 can include a series of software “layers” developed on top of the Wireless communication Station Modem (MSM) 218 and the Advanced Wireless communication Subscriber Software (AMSS) 220, developed by QUALCOMM®. In this example the underlying MSM chipset can implement the software protocol stack for the entire suite of CDMA communication technologies that include CDMA20001X and CDMA2000 1xEV-DO. In this example the AMSS 220 can be configured to support a wireless communication operating system layer 222, which in an embodiment is BREW®, also developed by QUALCOMM®. The wireless communication operating system layer 222 can provide an application programming interface for chip or device-specific operations, while providing an isolation layer that eliminates direct contact to the AMSS 220 and any OEM software on the mobile device 200. The wireless communication operating system layer 222 can enable application development that uses wireless communication device features without having to rewrite the application each time a new release of the device-specific software is released.

In this example the wireless communication operating system 222 can support a media client 224. The media client 224 can include instructions for sending/receiving media objects, e.g., video clips, audio clips, pictures, contact information, e.g., phone numbers and the like, etc. The media client 224 can use interfaces provided by the mobile operating system 222 (which can interface with the protocol stack) to send media objects to other mobile devices and/or the media server 53.

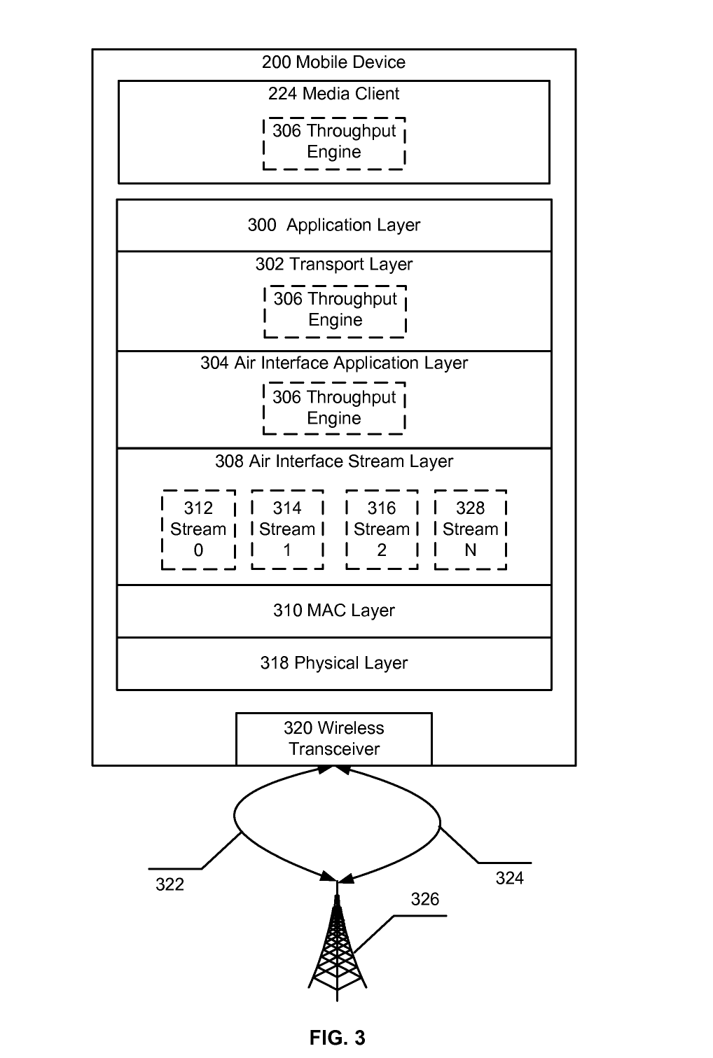

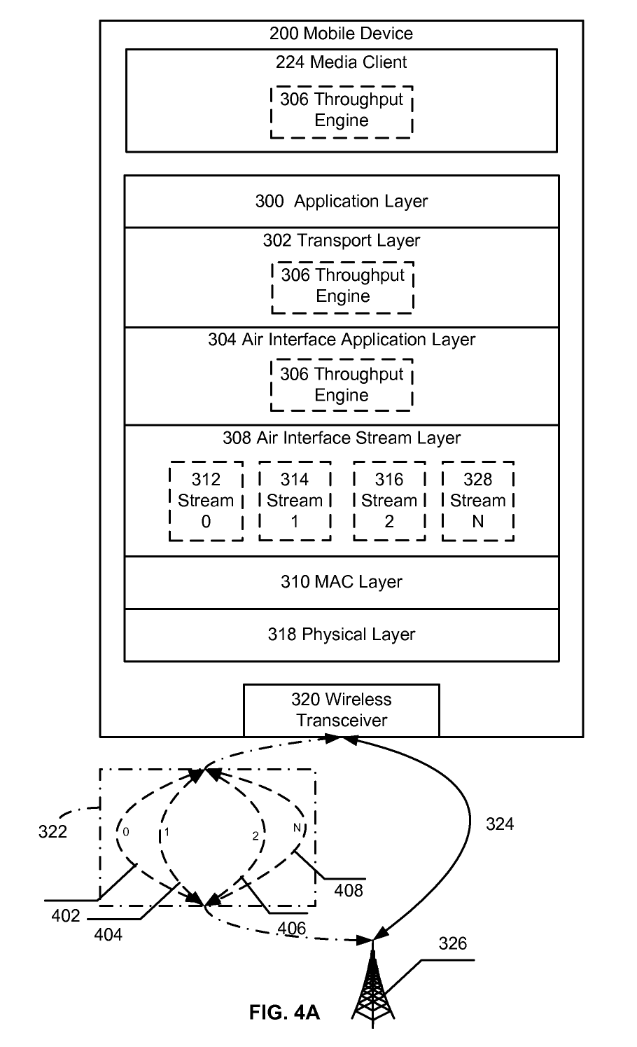

FIGS. 3 and 4 illustrate a mobile device 200 in communication with a base transceiver station 326. In FIG. 3 the wireless communication device 200 has is shown having two physical channels open with the base transceiver station 326 (channel 322 and channel 324) and in FIG. 4 the wireless communication device 200 is shown having many logical channels open (402-408) within physical channel 322. One skilled in the art can appreciate that in FIG. 4 the logical channels can be mapped to one or more physical channels, e.g. either channel 322 and/or 324 such as described in further detail below. Moreover, one of skill in the art can appreciate that the mobile device 200 can have more or fewer channels open than the amount depicted by FIGS. 3 and 4.

It should further be noted that channel 324 may not be available for all devices or application use, but can be preconfigured with the mobile service provider. The channels can reserved on a per session reservation, or the channels can be limited by the mobile service provider but it's something that the network operator agrees to provide to the device. Furthermore, 324 is not available in all situations, for example, available in EVDO but not in 1x.

The mobile device 200 includes a protocol stack that can be used to send multimedia objects to remote devices such as other mobile devices, computer systems such as computer system 100, or media server 530 of FIG. 5. Generally, the protocol stack comprises of layers that provide a flexible framework for sending/receiving data. For example, each layer can be a self contained object with predefined messages, procedures, and interfaces to other layers (objects) allowing for independent modification of the layers of the protocol. Accordingly, while some layers are discussed as including certain functions, those skilled in the art can appreciate that the functions can be implemented in different layers.

Turning to the figures, two OSI model layers are shown, namely, the application layer 300 and the transport layer 302 (while two layers are shown, in embodiments some, none, or all of the functions described in other OSI model layers can also be implemented in mobile device 200 in the two layers shown or in other layers). Furthermore, the OSI layering model is only shown for demonstrative purposes and other layering methodology can be used in the present system. Briefly, the application layer 300 is a layer that the media client 224 can directly interface with. Application layer functions may include, but are not limited to, identifying communication partners, determining resource availability, and synchronizing communication. The transport layer 302 can tag outgoing data with the port number of the application on the receiver and deliver data to the appropriate application process in the mobile device 200, e.g., media client 224, by routing data to the correct port(s).

In an example embodiment the mobile device 200 can include functions described in the High-rate packet data air interface specification (HRPD). In an example embodiment that includes these functions, packets can also be processed by functions associated with the different layers of the HRPD protocol. Briefly, the HRPD provides an air interface for mobile devices that is optimized for IP-based applications that have different QoS levels and demand a high amount of the available bandwidth. The HRPD protocol layers can include an air interface application layer 304, an air interface stream layer 308, a media access layer (MAC) 310, and a physical layer 318 along with other layers that are not shown. One skilled in the art can appreciate that the herein described techniques can be equally applied to other protocol stacks and that the disclosure is not limited to protocol stacks based off the HRPD or the OSI models.

The air interface application layer 304 does not refer to a layer that communicates with user applications, instead it can provide functions that control how signaling occurs and how data is sent to the access network. For example, the air interface application layer 304 can include a signaling application which includes functions for carrying messages between the mobile device 200 and computer systems in the access network, providing message fragmentation, and duplication detection. The air interface application layer 304 can also implement packet applications such as a point to point protocol (PPP), a radio link protocol (RLP), a location update protocol, and a flow control protocol. The flow control protocol can provide procedures and messages for sending/receiving data.

Briefly, the air interface application layer 304 can operate in conjunction with transport layer 302 by receiving data associated with a port and adding the data to its own RLP flow that can have its own QoS level. The QoS level can be set by an application or throughput engine 306 and air interface application layer 304 can include functions for receiving data and tagging the data with flow identifiers to enforce QoS rules.

Air interface stream layer 308 can include executable instructions for multiplexing distinct RLP flows into streams. For example, signaling flows can be multiplexed into a signal signaling stream and user data flows can be can be multiplexed into a variety of streams depending on their QoS. Air interface stream layer 308 can add flows to different streams by adding a stream header to outgoing packets, e.g., packets sent from the media client 224 and tagged by the air interface application layer 304. For received packets, the air interface stream layer 308 can remove the stream header and forward the packets to the correct application, e.g., media client 224. Each stream can be routed to a logical channel which is a communication path between the channel multiplex sublayers and objects in higher layers. A logical channel can be thought of as carrying the logical units, e.g., payload data units and service data units, and logical channels can be mapped to physical channels which can be thought of as the actual physical vehicle that transports the signaling or user information over the air. Physical channels are defined with orthogonal spreading codes and PN codes. In a CDMA embodiment a full duplex channel can include a reverse link, e.g., the path from the mobile device 200 to the base transceiver station 326, and the forward link, e.g., the path from the base transceiver station 326 to the mobile device 200. The forward links of the physical channels in a sector are time multiplexed on a single composite channel.

As shown by the figures, streams 0-N where N is an integer greater than 2 can exist in air interface stream layer 308. The streams can be stored in memory buffers (queues) such as a ring buffer of the like. Streams 312, 314, 316, and 328 are illustrated in dashed lines which is indicative of the fact that more or fewer streams can be effectuated and that the streams can be stored in one or more queues. Moreover, streams 312, 314, 316, and 328 can be mapped to one or more logical channels 402-408, which are shown here as across physical channel 322. It should be appreciated that the logical channels 0-N can travel across several physical channels if so embodied. Moreover, the virtual channels can be switched across physical channels transparently to applications. Each virtual channels can therefore have different QoS assigned depending upon the priority of transmission or other criteria. Furthermore, the virtual channels can allow the uploading and downloading of data in the same physical channel with different QoS assigned to each function. The mobile device could be embodied to assign the appropriate QoS to each calling application for each virtual channel to optimize use of the available physical channels and resources, and in some instances avoid deadlock in communications, delay of priority signaling, or conflicts.

Continuing with the description of FIGS. 3 and 4A-4B, a media access level layer “MAC” layer 310 is shown. MAC layer 310 can define procedures used to transmit and receive data over physical layer 318, enforce quality of service rules and prioritize channel access requests, map logical channels to physical channels, and schedule packets for transmission over transceiver 320. In an embodiment, MAC layer 310 can include a QoS/multiplexing function that can map logical channels into physical channels and enforce QoS rules. In an example CDMA embodiment a mobile device can send information over logical channels such as a reverse common signaling channel, reverse dedicated signaling channel, and the reverse dedicated traffic channel, e.g., a logical QoS channel or a logical short data burst channel. MAC layer 310 will receive the information and map it based on QoS to one or more physical channels such as the reverse supplemental channel, reverse supplemental code channel, reverse fundamental channel, a reverse dedicated control channel, the reverse access channel, the reverse enhanced access channel, and the reverse common control channel.

Generally, physical layer 318 specifies channel structure, frequency, power output, modulation and encoding for forward and reverse channels. The physical layer 318 generates the electrical signals indicative of information so that the wireless transceiver 320 can send it over the air.

As shown in FIGS. 3 and 4A-4B, in an example embodiment the media client 224, the air interface application layer 304, the transport layer 302, and/or any other protocol layer can include a throughput engine 306. One skilled in the art can appreciate that the throughput engine 306 is illustrated in dashed lines which is indicative of the fact that it can be implemented in a single layer or it can be distributed and implemented in multiple layers. Briefly, and described in more detail below, the throughput engine 306 can be configured to increase throughput during file sharing operations.

As shown in an alternate embodiment of FIG. 4B, the mobile device can have a wireless receivers/transceiver 320, with a plurality of antennae 321 and 323. The wireless transceiver can host a separate physical channel with each antennae 321 and 323, to create a general virtual channel 325, as shown in this embodiment. As shown herein, the virtual channels 0-L exist on channel 325 to antennas 321 and 323. Thus, the sum of all virtual channels is designated as L (here shown on virtual channel 409) which are carried in the multiple physical channels when multiple antennae are present. It should be appreciated that the virtual channels and data streams can be varied across whatever physical channels are available to the mobile device. One of such channels might be a “data over signaling” or “DoS” channel, as is present in a WCDMA system. Other logical channels could be pure signaling channels, data channels, or voice channels, with potentially varying QoS for each channel.

Turning to FIG. 5, illustrated is an exemplary wireless network. The wireless network is merely exemplary and can include any system whereby remote modules communicate over-the-air between and among each other and/or between and among components of a wireless network, including, without limitation, wireless network carriers and/or servers. As illustrated by the figure, mobile device 200 (while one mobile device is shown one skilled in the art can appreciate that many more can simultaneously use the wireless network) can be in wireless communication with an access network 504 which can include base transceiver station 326 and base station controller 502. Access network 504 includes the equipment that provides data connectivity between a packet-switched data network and the mobile devices. An access node authentication, authorization, and accounting server “AAA” 528 used to authenticate mobile devices can be coupled to a database operable to store information such as user accounts and privileges.

Continuing with the description of FIG. 5, data packets can be routed from the access network 504 to the packet data servicing node 508 (PDSN) via a packet controlled function 506 (PCF). PCF 506 is an element, e.g., one or more computer systems, that controls the transmission of packets between an access network and a PDSN. The PCF can be configured to keep track of registration and sessions, control available radio resources, buffer data received from PDSN until radio resources are available, etc. PDSN 508 includes equipment configured to provide data connectivity between a media server 530 configured to store media objects for users and an access network and a packet-switched data network 510 such as the Internet. Other servers can be within the wireless network, similar to media server 530, than can provide data interactivity with mobile devices on the wireless network as is further described herein.

Voice packets can be routed to a mobile switching center 512 (MSC). A MSC is the primary service delivery node responsible for handling voice calls and SMS as well as other services (such as conference calls, FAX and circuit switched data). Connected to a MSC 512 is a home location register 516 (HLR) and the public switched telephone network 514 (PSTN). The HLR is the location register to which a user identity is assigned for record purposes such as subscriber information. The HLR is the first database that is interrogated to obtain mobile location and routing information once a mobile device's number is dialed by a user outside the network.

The following are a series of flowcharts depicting operational procedures. The flowcharts are organized such that the initial flowcharts present implementations via an overall viewpoint. Those having skill in the art can appreciate that the style of presentation utilized herein, e.g., beginning with a presentation of a flowchart(s) presenting an overall view and thereafter providing additions to and/or further details in subsequent flowcharts, generally allows for a rapid and easy understanding of the various operational procedures. Furthermore, those of skill in the art that certain operations can be executed in a different order than described herein, thus, the disclosure is not limited to any specific order of operations.

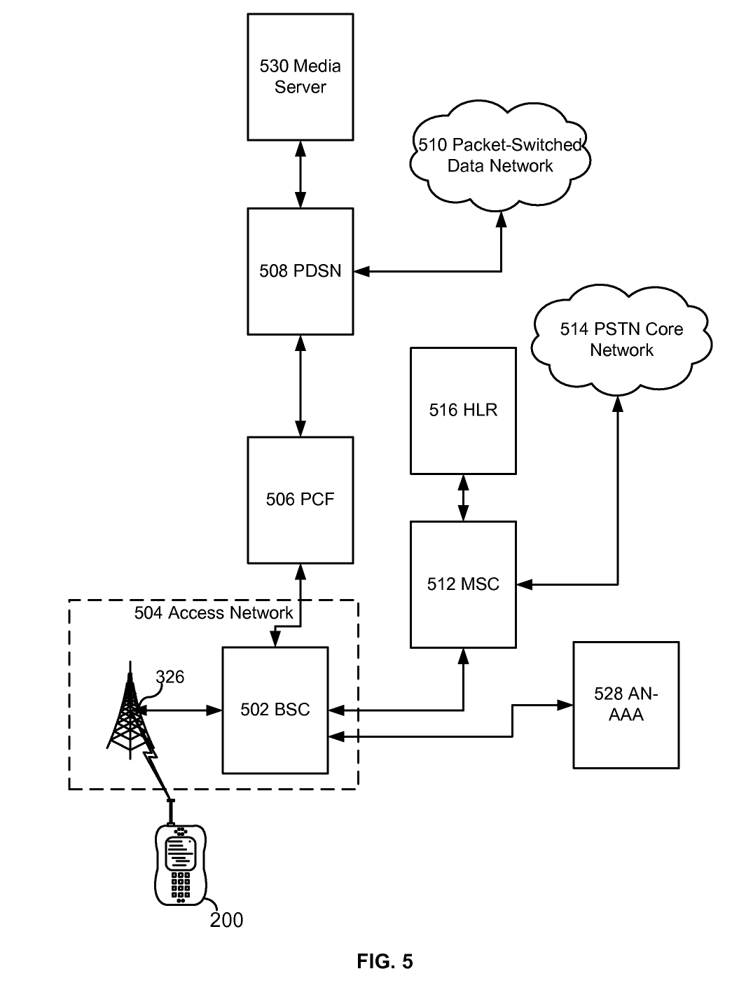

Turning to FIG. 6, illustrated is an operational procedure for practicing aspects of the present disclosure including operations 600-604. Operation 600 begins the operational procedure and operation 602 shows simultaneously uploading first data (packetized in another format) and downloading second data via a wireless channel. For example, and turning to FIG. 4, first data associated with a logical channel such as logical channel 402 can be sent over a forward link of a wireless physical channel to a base transceiver station 326. In an example embodiment the first data can be associated with a first stream and stored in a buffer prior to it being sent via the wireless physical channel. That is, the first data is queued and processed before it is sent to the base transceiver station 326. In this example a media client 224 can have determined to send first data, e.g., multimedia content, to a remote device, e.g., a computer system 100, media server 530 or another mobile device. The first data can traverse the different protocol layers and have information added, removed, or processed and stored in a queue so that it can be sent via the transceiver 320. In a specific example the first data can be associated with a stream such as stream 314. In this example the air interface stream layer 308 could have checked the flow identifier of the first data and multiplexed the first data with other data that has the same QoS level and stored the data in queue. As frames of the first data are transmitted by wireless transceiver 320 the amount of first data in the queue can decrease.

In an embodiment the second data can be a portion of a multimedia object, a media object, a contact object, an audio object or the like. For example, in an embodiment the second data can be indicative of a first portion of a multimedia object, a contact object, e.g., it can be an object that includes a name, telephone number, address, email address, etc., of a person, an audio object, e.g., a song or a voice message. In addition to the foregoing the first data can also be a multimedia object, a media object, a contact object, an audio object or the like.

Continuing with the description of FIG. 6, operation 604 shows sending the acknowledgment over the reverse link of the wireless channel before at least a portion of the first data has been sent over the wireless channel. Typically, when an acknowledgment is generated, it is associated with the flow (and thus the same logical channel) the application uses and thus buffered behind any data that has been previously stored and hasn't been sent out yet. If there is a lot of queued data, or the bandwidth of the logical channel is low, the potential that a timeout will occur while the ACK is queued increases. Thus, both data flows will be timed out. In an example embodiment though, the present throughput engine 306 can be configured to determine when an acknowledgment will timeout and route the ACK to a QoS stream 316 in order to bypass the buffered first data and avoid this situation.

In a specific exemplary embodiment the ACK can be sent in the same logical channel as the first data. Here, the logical channel could be an IP data flow or a higher layer data flow, such as a session initiation protocol (SIP) layer data flow. In this specific example throughput engine 306 can execute and tag the ACK with a flow identifier that routes the ACK to a stream that is associated with the same logical channel used to send the first data but is associated with a higher QoS. For example, the first data could be sent over the reverse dedicated traffic channel (e.g. the “reverse link transmission over a traffic channel” in the EvDO standard) and the ACK could be associated with the same logical channel but be associated with a different stream within the channel. In this example a function in MAC layer 310 can be configured to detect the ACK in a QoS queue and schedule it to be sent before the first data.

In another specific example embodiment the acknowledgment can be sent over a different logical channel used to send the first data, e.g., first data could be sent via the reverse dedicated traffic channel and the ACK could be sent via the reverse dedicated signaling channel. In this example, the acknowledgment for the second data can be associated with a second flow by throughput engine 306 that is associated with a different logical channel than the logical channel used to send the first data. The acknowledgment can then be multiplexed with other data that has the same level of QoS into a prioritized stream such as stream 316 that is part of logical channel 404 and logical channel 404 can guaranteed a level of service that is at least better than logical channel 402 associated with the first stream 314. It should be noted that, in general, signaling channels are always usable and have higher priority over traffic channels in wireless communication systems, though the signaling channels typically only support low data rates. Thus, since the ACKs are typically sufficiently small messages, they can fit in the signaling channel efficiently despite the low data transfer rates.

In an example embodiment throughput engine 306 can be effectuated at least in part in the media client 224 and the media client can be bound to multiple data flows and ports, e.g., a QoS port and a regular port and each port can be associated with a different flow. In this exemplary embodiment, the throughput engine 306 can send the ACKs on the QoS port instead of on the regular port. In this example embodiment the transport layer 302 can direct ACKs with QoS port numbers, the air interface application layer 304 can tag the ACKs with prioritized flow identifiers, and the air interface stream layer 308 can associate the ACKs with prioritized stream identifiers. In one example embodiment the data associated with the prioritized stream identifiers can be associated with a logical channel that receives preferential treatment. In another example embodiment data associated with the prioritized stream identifiers can be inserted in a logical channel ahead of data is associated with a stream having a lower QoS.

In an example embodiment throughput engine 306 can be effectuated at least in part in the transport layer 302 and the throughput engine 306 can detect ACKs on the regular port and tag them with the QoS port number thereby changing the flow that the ACKs joins. In this example the media client 224 would not have to be changed. In this example embodiment the transport layer 302 can tag ACKs with QoS port numbers, the throughput engine 306 can change the port number to the QoS port, the air interface application layer 304 can tag the ACKs with prioritized flow identifiers, and the air interface stream layer 308 can associate the ACKs with prioritized stream identifiers. In one example embodiment the data associated with the prioritized stream identifiers can be associated with a logical channel that receives preferential treatment. In another example embodiment data associated with the prioritized stream identifiers can be inserted in a logical channel ahead of data is associated with a stream having a lower QoS.

In another example embodiment the throughput engine 306 can be effectuated at least in part in the air interface application layer 304. In this example the throughput engine 304 can receive ACKs associated with one flow and change the flow identifier to a higher priority flow thereby changing the flow that the ACK will be contained in. In this example embodiment the transport layer 302 can tag the ACKs with QoS port numbers, the air interface application layer 304 can tag the ACKs with prioritized flow identifiers, the throughput engine 306 can change the flow identifier to that of the QoS flow, and the air interface stream layer 308 can associate the ACKs with prioritized stream identifiers. In one example embodiment the data associated with the prioritized stream identifiers can be associated with a logical channel that receives preferential treatment. In another exemplary embodiment data associated with the prioritized stream identifiers can be inserted in a logical channel ahead of data is associated with a stream having a lower QoS.

It should thus be appreciated that the present system creates efficiency in that data can be sent to a high processing power/storage server and be received from the same high processing power/storage server such that more enabling aspects of applications and processing can reside on the server. For example, historical traffic capacities were graphed by day, traffic patterns can be predicted in a busy hour during the day more accurately and the server could provide some information to the client to this effect (as part of the packets sent). As maintaining QoS is usually expensive, it typically limits the speed of upload as there is a maximum amount of bandwidth allocable. Therefore, the present system can also be used to optimize the spectral efficiency of the network to allocate the requisite QoS as necessary for the data flows.

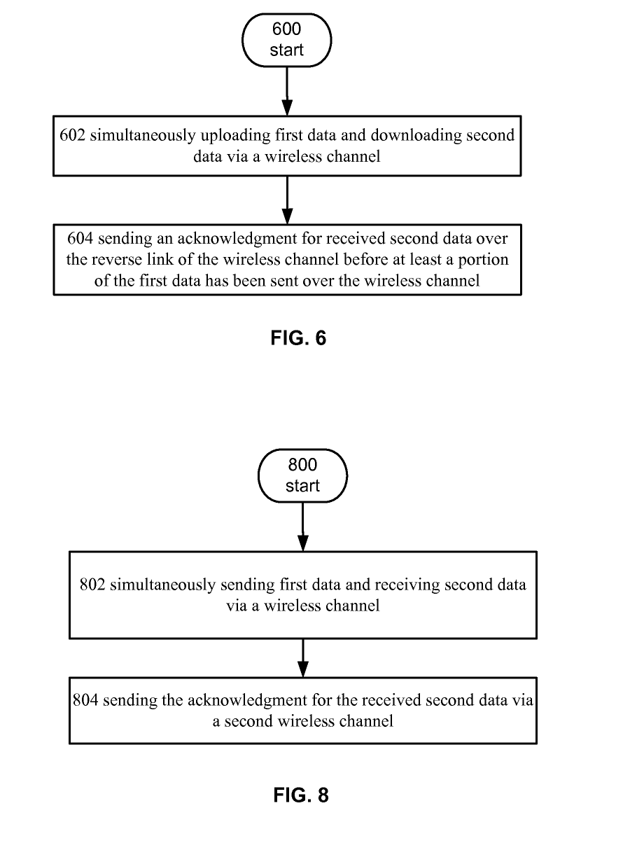

Turning now to FIG. 7, illustrated is an alternative embodiment of the operational procedure of FIG. 6 including operations 706-712. Turning to operation 706, it depicts determining that the bandwidth of the wireless channel is lower than a predetermined threshold. For example, in an embodiment the throughput engine 306 can be configured to determine the bandwidth of the reverse link from, for example, the ratio of an amount of data sent and the amount of time it took to receive an acknowledgment. In addition, to prevent spiky bandwidth false positives, each instantaneous bandwidth sample could be used either directly or passed through filtering algorithms such as a moving or exponential averaging method. In another specific example, one in which the mobile device 200 currently has multiple parallel sessions opened with different media servers, then the handset can use well-known techniques like Packet-Pair or CapProbe to estimate link bandwidth. When the bandwidth is below a predetermined threshold throughput engine 306 can be configured to send acknowledgments via a prioritized stream. The air interface stream layer 308 can then add the ACK to a stream that includes prioritized data that is given preferential treatment. Thus, it should be appreciated that without utilization of the multiple virtual channels here to handle operations 706, 708, 710, 712 in parallel, the channel would accordingly be in a deadlock attempting to pass multiple data streams. Moreover, the QoS of each virtual channel can be assigned as necessary for priority of transmission.

Continuing with the description of FIG. 7, operation 708 shows determining that the load on the base transceiver station is higher than a predetermined threshold. For example, in an embodiment throughput engine 306 can be configured to receive information that defines the load on the base transceiver station 326 and be configured to associate acknowledgments with a prioritized stream. For example, a medium access control channel can include load information such the number of channels in use, the level of activity in sector, e.g., interference level, etc., and throughput engine 306 can determine compare the load information to a value stored in memory to determine whether the load information indicates that the load on the base transceiver station 326 is larger than a predetermined value. Alternately, the rate at which ACKs are sent over the QoS flow can be a defined by a function of load rather than a simplistic threshold rule (which is a step function). Such functions could also be probabilistic in their characterization. i.e., if the load in the sector is L, where 0%<=L<=100% then the probability of promoting an ACK to a QoS flow is defined by the function F(L). If it is, then the throughput engine 306 can be configured to prioritize acknowledgments by, for example, changing the port number the ACK is tagged with, or changing the flow the ACK is in. By prioritizing the ACK in this manner the ACK will be placed in a different stream than the first data.

Turning to operation 710, it shows receiving a retransmitted packet indicative of a portion of the second data. In an example embodiment throughput engine 306 can be configured to operate in a reactive mode. For example, in the instance that a retransmitted packet indicative of the second data is received it can be inferred that the acknowledgments are not being sent on time. Thus, in this example embodiment throughput engine 306 can be configured to prioritize acknowledgments by associating them with stream 316 instead of stream 314. In the same, or another embodiment instead of merely prioritizing acknowledgments after a retransmitted packet is received throughput engine 306 can first measure the current bandwidth of the wireless channel to determine whether there is a throughput problem (to avoid unnecessary ACK transmissions over the QoS flow if there is a connectivity problem). In the instance that a bottleneck is detected throughput engine 306 can be configured to prioritize acknowledgments by associating them with stream 316 instead of stream 314. In the same, or another embodiment throughput engine 306 can also compare load information to a value stored in memory to determine whether the load information indicates the load on the base transceiver station 326 is higher than a predetermined value. If it is, then the throughput engine 306 can be configured to prioritize acknowledgments by associating them with stream 316 instead of stream 314.

Turning to operation 712, it shows determining that the acknowledgment will not be sent within a predetermined amount of time based on an estimated amount of time the acknowledgment will be queued. For example, in an embodiment the throughput engine 306 can be configured to calculate the delay before acknowledgements will be sent based on the amount of data presently queued before the ACK and the current bandwidth. In this example throughput engine 306 can include information that describes a time that the acknowledgment must be received before the device sending the second data concludes that the second data was lost. In this example the throughput engine 306 can be configured to prioritize acknowledgments by changing the stream the ACK will be associated with to a prioritized stream when it is calculated that the acknowledgment would not reach the destination within the allotted time. Alternately, the estimative behavior can be handled remotely, such as at server 530, to make an estimate based on historical data and/or a learning algorithm, and provide the calculation back to the mobile device. Likewise, the mobile device 200 can provide data to the server of network conditions, such as the condition of the physical channel 322 such that the server (such as media server 530) can determine the optimal prioritization of acknowledgements and transmit this calculation to the mobile device 200. However, having such functionality at the mobile device 200 does increase the resident resource cost.

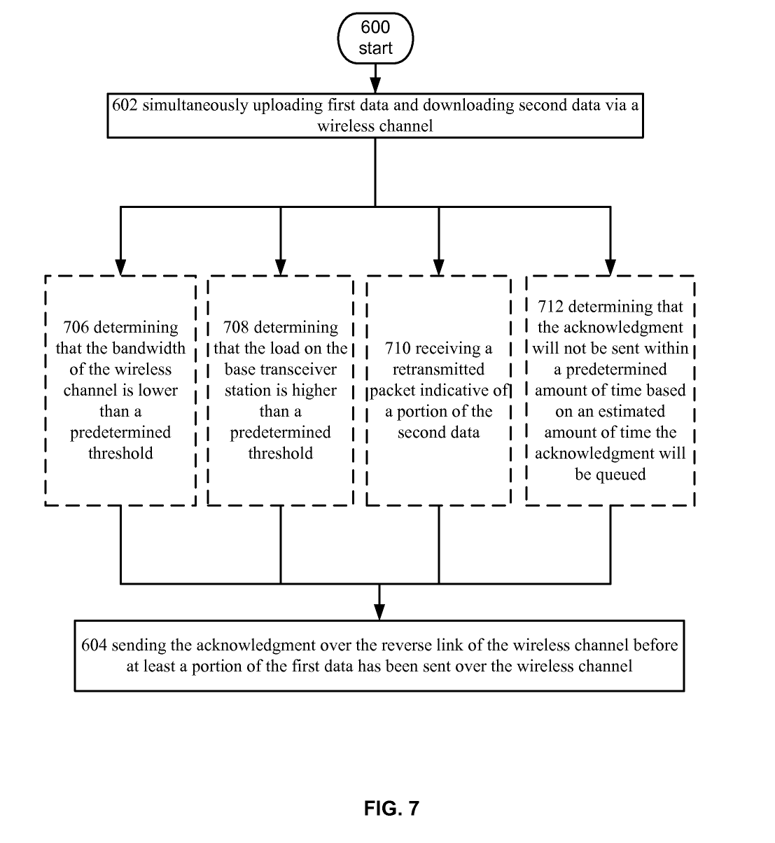

Turning now to FIG. 8, it illustrates an operational procedure for practicing aspects of the present disclosure including operations 800, 802, and 804. Operation 800 begins the procedure and operation 802 shows simultaneously sending first data and receiving second data via a wireless channel. For example, and turning to FIG. 8 transceiver 320 can simultaneously send first data over the reverse channel and receive second data over the forward channel of physical channel 322. That is, in an example embodiment the mobile device 200 can receive and send data at the same time. As portions of the first data are transmitted by wireless transceiver 320 the amount of first data in a protocol buffer can decrease.

Turning now to operation 804, there is shown sending the acknowledgment for the received second data via a second wireless channel. For example, in an embodiment throughput engine 306 can be configured to send an acknowledgment for the received second data via a different channel than the first data, such as channel 324 is so configured. Throughput engine 306 can in this example insert the acknowledgment into a flow that is associated with a different physical channel than the one that is sending the first data. In an exemplary embodiment, the mobile device 200 can include multiple antennas and thus have multiple reverse data channels so that it can simultaneously transmit on two code channels. In a specific example the first data could be sent via the reverse fundamental channel and the ACK could be sent by the reverse supplemental channel. In another specific example, the second channel can be signaling channel such as a data rate control channel, a pilot channel, a reverse rate indicator channel, or a pilot channel. Signaling data may be significantly less bandwidth intensive than user data such as first data and the ACK will be sent via a channel must faster than if it was queued behind first data and sent via first channel. This is of course dependent on the specific protocols used for transmission, such as CDMA, WCDMA, or EvDO. For example, some protocols consider signaling channels against the best practices for the protocol as they decrease spectral efficiency. The present system can thus allow signaling channels in the physical channel of a protocol that otherwise does not allow or disfavors them.

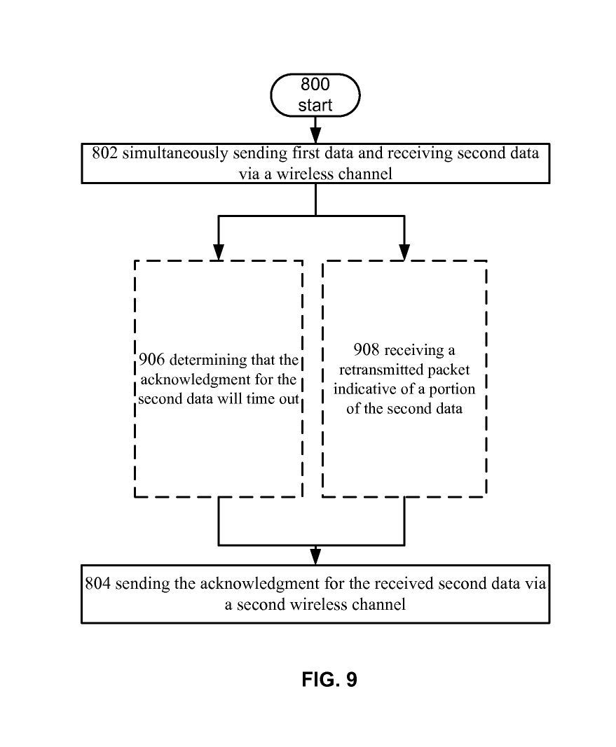

Turning now to FIG. 9, it illustrates an alternative embodiment of the operational procedure including operations 906 and 908. Turning to operation 906, it illustrates that in an example embodiment throughput engine 306 determine that the ACK will time out. In this example embodiment throughput engine 306 can change the flow identifier for the ACK so that it is routed to a stream that is associated with a different physical channel than the first data. In an embodiment this determination can be based on how much first data is queued in front of an ACK, the measured data rate, and/or the current bandwidth. For example, if the estimated data rate falls so low such that an ACK would not be sent in time, then that ACK can get “promoted” to use channel 324 as opposed to channel 322. If for example, at a later point in time the bandwidth increases beyond a specific threshold, then future ACKs can be demoted once again to the regular channel 322.

In another example embodiment throughput engine 306 can be configured to calculate the delay that will occur before an acknowledgement is sent due to the amount of first data queued before the ACK and the current bandwidth and determine that the ACK won't be sent in time by comparing it to a value stored in memory. In this case the throughput engine 306 can change the flow identifier for the ACK so that it is part of a different flow that is sent over a different channel.

In another embodiment the determination that the ACK will not be sent within a predetermined amount of time can be based in part on information that identifies the load on the base transceiver station 326. In this embodiment throughput engine 306 can be configured to receive information that defines the load on the base transceiver station 326 and be configured to send ACKs via a prioritized channel by, for example, changing the flow identifier for the ACK to a flow identifier associated with a different channel. For example, a medium access control channel can include load information such the number of channels in use, the level of activity in sector, e.g., interference level, etc., and the throughput engine 306 can determine compare the load information to a value stored in memory to determine whether the load information indicates the load on the base transceiver station 316 is lower than a predetermined value. If it is, than the mobile device can open another channel with the base transceiver station 326 and send the ACK via this channel.

Continuing with the description of FIG. 9, it shows receiving a retransmitted packet indicative of a portion of the second data. In an example embodiment throughput engine 306 can be configured to operate in a reactive mode. For example, in the instance that a retransmitted packet indicative of the second data is received it can be inferred that the acknowledgments are not being sent on time. Thus, in this example embodiment throughput engine 306 can be configured to prioritize acknowledgments by changing the flow identifier for the ACK to a flow identifier associated with a different channel when a retransmitted packet of information is received. In an embodiment the throughput engine 306 can also measure the current bandwidth of the wireless channel to determine whether there is a throughput problem when a retransmitted packet is received. In the instance that a bottleneck is detected the throughput engine 306 can be configured to prioritize acknowledgments by changing the flow identifier or the port identifier for the ACK to have the ACK sent via a priority channel.

It should be appreciated that the use of the signaling channel can be minimized in this configuration. Furthermore, the system can be embodied to check and ensure that the signaling channel is not overloaded before promoting traffic to it for upload, although such embodiment is protocol dependent.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A system for transmitting and receiving data from a mobile device, comprising:
a first base transceiver station;
a mobile device configured to send first data to the base transceiver station over a reverse link of at least a physical first wireless channel;
wherein the mobile device is configured to receive second data sent from the base transceiver station on a forward link of the first wireless channel while sending the first data to the base transceiver station over the reverse link of the first wireless channel; and
wherein the mobile device is configured to send an acknowledgement signal for the second data to the base transceiver station on at least a logical second wireless channel while sending the first data to the base transceiver station over the reverse link of the first wireless channel.

2. The system of claim 1, wherein the second channel is established over a signaling channel.

3. The system of claim 1, wherein the second channel is a prioritized channel that has a higher quality of service than the first channel.

4. The system of claim 1, further including at least one server that communicates data at least across the second channel with the mobile device.

5. The system of claim 1, wherein the first data includes a multimedia object.

6. A system for sending and receiving data from a mobile device, comprising:
a mobile device configured to store a first portion of first data and a second portion of the first data in a wireless transceiver queue;
wherein the mobile device is configured to send the first portion of the first data to a base transceiver station over a reverse link of at least a first physical wireless channel;
wherein the mobile device is configured to receive second data sent from the base transceiver station on a forward link of the wireless channel while sending the first portion of the first data to the base transceiver station over the reverse link of the wireless channel;
wherein the mobile device is configured to store an acknowledgement signal for the second data into a second queue; and
wherein the mobile device is configured to send the stored acknowledgment signal for the second data over the reverse link of the wireless channel before sending the second portion of the first data.

7. The system of claim 1, wherein the first data includes a portion of a multimedia object.

8. The system of claim 1, wherein the first data includes a multimedia object.

9. A mobile device, comprising:
circuitry for sending first data over a reverse link of a wireless channel, the first data associated with a first protocol stream;
circuitry for generating, while sending the first data over the reverse link of the wireless channel, an acknowledgment for received second data;
circuitry for associating the acknowledgment with a second stream; and
circuitry for sending the acknowledgment over the reverse link of the first channel before at least a portion of the first data has been sent over the first channel.

10. The mobile device of claim 9, further comprising:
circuitry for storing the acknowledgment in a queue effectuated in a media access layer of a protocol stack.

11. The mobile device of claim 9, further comprising:
circuitry for executing a file sharing application; and
circuitry for binding a media client to first and second port, wherein the acknowledgment is associated with the second port and the first data is associated with the first port.

12. The mobile device of claim 9, further comprising:
circuitry for determining that the bandwidth of the wireless channel is lower than a predetermined threshold; and
circuitry for configuring the mobile device to associate acknowledgments with the second stream.

13. The mobile device of claim 9, further comprising:
circuitry for receiving information that indicates that the load on the wireless channel to the base transceiver station is below a predetermined threshold; and
circuitry for configuring the mobile device to associate acknowledgments with the second stream.

14. The mobile device of claim 9, further comprising:
circuitry for determining an amount of time that acknowledgments will be queued based on current bandwidth information and an amount of first data stored in the queue; and
circuitry for determining that the acknowledgment will not be sent within a predetermined amount of time based on the determined amount of time that acknowledgments will be queued.

15. The mobile device of claim 9, further comprising:
circuitry for receiving a retransmitted packet indicative of a portion of the second data; and
circuitry for configuring the mobile device to prioritize acknowledgments.

16. The mobile device of claim 9, further comprising:
circuitry for receiving a retransmitted packet indicative of a portion of the second data;
circuitry for determining that the bandwidth of the wireless channel is lower than a predetermined threshold; and
circuitry for configuring the mobile device to prioritize acknowledgments.

17. The mobile device of claim 9, further comprising:
circuitry for receiving a retransmitted packet indicative of a portion of the second data;
circuitry for receiving information that indicates that the load on the base transceiver station is below a predetermined threshold; and
circuitry for configuring the mobile device to prioritize acknowledgments.

18. A mobile device, comprising:
means for simultaneously sending first data and receiving second data via a wireless channel;
means for determining that the second data has be received and that the first data is being sent; and
means for sending an acknowledgment for the second data via a priority wireless channel, wherein the wireless channel is a different channel than the priority wireless channel.

19. The mobile device of claim 18, further comprising:
means for determining that the acknowledgment for the second data will not be sent within a predetermined time period based on a calculated amount of time required to send the first data stored in a queue and a determined bandwidth of the wireless channel.

20. The mobile device of claim 18, further comprising:
means for determining that the acknowledgment for the second data will not be sent within a predetermined time period based the bandwidth of the wireless channel and an amount of first data stored in a queue.

21. The mobile device of claim 18, wherein the second data is a portion of a multimedia object.

22. The mobile device of claim 18, wherein the second data is a contact object.

23. The mobile device of claim 18, wherein the second data is an audio object.

24. The mobile device of claim 18, wherein the priority wireless channel is a data over signaling channel.

25. The mobile device of claim 18, further comprising:
means for queuing the acknowledgment in an air interface stream layer queue.

26. The mobile device of claim 18, further comprising:
means for receiving information that indicates that the load on the base transceiver station is below a predetermined threshold; and
means for configuring the mobile device to send acknowledgments via the priority channel.

27. The mobile device of claim 18, further comprising:
means for receiving a retransmitted packet indicative of a portion of the second data; and
means for configuring the mobile device to send acknowledgments via the priority channel.

28. The mobile device of claim 18, further comprising:
means for receiving a retransmitted packet indicative of a portion of the second data;
means for determining that the bandwidth of the wireless channel is lower than a predetermined threshold; and
means for configuring the mobile device to send acknowledgments via the priority channel.

29. The mobile device of claim 18, further comprising:
means for receiving a retransmitted packet indicative of a portion of the second data;
means for receiving information that indicates that the load on the base transceiver station is below a predetermined threshold; and
means for configuring the mobile device to send acknowledgments via the priority channel.

30. A mobile device method, comprising:
simultaneously uploading first data and downloading second data via a wireless channel;
completing the download of the second data;
determining that an acknowledgment for the downloaded second data would not be sent within a time limit based on the bandwidth of the wireless channel and an amount of first data stored in a queue; and
sending the acknowledgment for the second data via a second wireless channel.

31. A computer readable storage medium including computer executable instructions, the computer readable storage medium comprising:
instructions for simultaneously uploading first data and downloading second data via a second wireless channel;
instructions for receiving information that indicates that the load on a base transceiver station is below a predetermined threshold; and
instructions for sending an acknowledgment for the second data via a second wireless channel.

32. A computer readable storage medium including computer executable instructions, the computer readable storage medium comprising:
instructions for simultaneously uploading first data and downloading second data via a wireless channel;
instructions for determining that an acknowledgment for the downloaded second data would not be sent within a time limit based on the bandwidth of the wireless channel and an amount of first data stored in a queue;
instructions for associating the acknowledgment for the second data with a prioritized stream; and
instructions for sending the acknowledgment for the second data ahead of at least a part of the first data stored in the queue.

33. A method for transmitting and receiving data at a mobile device, comprising:
simultaneously uploading first data associated with a first stream and downloading second data via a wireless channel;
determining that the load on a base transceiver station is below a predetermined threshold based on information that indicates the current load on the base station;
associating an acknowledgment for the second data with a second stream; and
sending the acknowledgment for the second data ahead of at least a part of the first data stored in the queue.

34. A computer readable storage medium including processor executable instructions, comprising:
instructions for queuing first data in a protocol stack, the first data associated with a first port number;
instructions for generating, while a first portion of the first data is being sent over a reverse link of a wireless channel, an acknowledgment for received second data;
instructions for queuing, while the first portion of first data is being sent over the reverse link of the wireless channel, the acknowledgment for the received second data, the acknowledgment associated with a second port number; and
instructions for transmitting the acknowledgment over the reverse link of the wireless channel ahead of at least a second portion of the first data.

35. A mobile device, comprising:
circuitry for queuing first data in a protocol stack, the first data associated with a first port number;
circuitry for generating, while the first data is being sent over a reverse link of a first wireless channel, an acknowledgment for received second data;
circuitry for queuing, while the first data is being sent over the reverse link of the first wireless channel, the acknowledgment for the received second data, the acknowledgment associated with a second port number; and
circuitry for transmitting, while the first data is being sent over the reverse link of the first wireless channel, the acknowledgment over a reverse link of a second wireless channel.

36. A mobile device, comprising:
circuitry for simultaneously sending first data associated with a first logical channel mapped to a physical wireless channel and receiving second data over the physical wireless channel; and
circuitry for sending an acknowledgment for received second data in a second logical channel mapped to the physical wireless channel.

37. A computer readable storage medium, comprising:
instructions for simultaneously sending first data associated with a first logical channel mapped to a physical wireless channel and receiving second data over the physical wireless channel; and
instructions for sending an acknowledgment for received second data in a second logical channel mapped to the physical wireless channel.

38. A method, comprising:
simultaneously sending first data associated with a first logical channel mapped to a physical wireless channel and receiving second data over the physical wireless channel; and
sending an acknowledgment for received second data in a second logical channel mapped to the physical wireless channel.

39. A mobile device, comprising:
circuitry for simultaneously sending first data and receiving second data over a physical wireless channel; and
circuitry for sending an acknowledgment for received second data over a second physical wireless channel.

40. A computer readable storage medium, comprising:
instructions for simultaneously sending first data and receiving second data over a physical wireless channel; and
instructions for sending an acknowledgment for received second data over a second physical wireless channel.

41. A mobile device, comprising:
at least one antenna for transmission and receipt of data;
circuitry configured to send first data to a base transceiver station over a reverse link of at least a physical first wireless channel;
circuitry configured to receive second data sent from the base transceiver station on a forward link of the first wireless channel while sending the first data to the base transceiver station over the reverse link of the first wireless channel; and
circuitry configured to send an acknowledgement signal for the second data to the base transceiver station on at least a logical second wireless channel while sending the first data to the base transceiver station over the reverse link of the first wireless channel.

42. The mobile device of claim 41, further comprising:
a plurality of antennas, each antenna for the establishment of at least one physical wireless channel; and wherein
a plurality of physically channels are configured through the plurality of antennas.

43. The mobile device of claim 41, further comprising a plurality of logical wireless channels for the sending of one or more acknowledgment signals for the second data.

44. The mobile device of claim 42, further comprising a plurality of logical wireless channels for the sending of one or more acknowledgment signals for the second data.

45. A system for increasing data throughput over a wireless network during a file sharing operation at a mobile device, comprising:
a first base transceiver station that selectively hosts data transfer on a wireless network;
at least one computer device in selective communication with a mobile device on the wireless network a mobile device on the wireless network configured to send first data to the base transceiver station over a reverse link of at least a physical first wireless channel;
wherein the mobile device is configured to receive second data sent from the base transceiver station on a forward link of the first wireless channel while sending the first data to the base transceiver station over the reverse link of the first wireless channel; and
wherein the mobile device is further configured to send an acknowledgement signal for the second data to the base transceiver station on at least a logical second wireless channel while sending the first data to the base transceiver station over the reverse link of the first wireless channel; and
wherein the computer device is configured to determine the priority of data transmission across at least the first wireless channel and second wireless channel by the mobile device and selectively transmits data to the mobile device such that the mobile device selectively prioritizes at least the second wireless channel to have a higher quality of service than the first wireless channel.

46. The system of claim 45, wherein the mobile device is further configured to detect the condition of at least the first wireless channel and transmit data indicative of the condition to the computer device.

47. A computer device for increasing data throughput over a wireless network during a file sharing operation at a mobile device, the computer device configured to determine the priority of data transmission across at least a first physical wireless channel of a mobile device on a wireless network and at least a logical second wireless channel of the mobile device, the computer device further configured to selectively transmit data to the mobile device such that the mobile device selectively prioritizes at least the second wireless channel to have a higher quality of service than the first wireless channel.

48. The computer device of claim 47, wherein the computer device further configured to receive data from at least one mobile device indicative of the condition of at least the first wireless channel of the mobile device.

49. A computer device for increasing data throughput over a wireless network during a file sharing operation at a mobile device, comprising:
means for determining the priority of data transmission across at least a first physical wireless channel of a mobile device on a wireless network and at least a logical second wireless channel of the mobile device; and
means for selectively transmitting data to the mobile device such that the mobile device selectively prioritizes at least the second wireless channel to have a higher quality of service than the first wireless channel.
